(19) United States
(12) Patent Application Publication
(10) Pub. No.: US 2011/0061889 A1
(43) Pub. Date: Mar. 17, 2011

(54) Braided cable

(75) Inventor: Samuel John Edward King, Singapore (SG)

(73) Assignee: Razer (Asia-Pacific) Pte Ltd, Singapore (SG)

(21) Appl. No.: 12/584,750

(22) Filed: Sep. 11, 2009

(51) Int. Cl. H01B 9/02; G06F 1/16

(52) U.S. Cl. 174/103; 361/679.4

(57) ABSTRACT

A cable including a number of cords of wires. The cords of wires are braided together in a predetermined braiding pattern. Each cord of wires includes a number of wires. The wires of each cord of wires are braided together in a predetermined braiding pattern. The cable further includes a cable insulator that collectively encapsulates the cords of wires. The cable further includes cord insulators. Each cord insulator collectively encapsulates the wires of each cord of wires. Each wire is encapsulated within a wire insulator. At least one of the cable insulator, the cord insulator, and the wire insulator is braided in a predetermined braiding pattern. The braiding of the cords of wires, the wires of each cord of wires, the cable insulator, the cord insulator, and the wire insulator, enhances at least one of flexibility and tensile strength of the cable. The braiding of the cords of wires, the wires of each cord of wires, the cable insulator, the cord insulator, and the wire insulator preferably decreases propensity of kink formation in the cable. A method for manufacturing cables is also provided by the present disclosure.

### FIELD OF DISCLOSURE

The present disclosure relates generally to cables. More specifically, the present disclosure relates to cables that are manufactured using braiding processes, methods, or techniques.

### BACKGROUND

A computer mouse typically facilitates translation of a two-dimensional movement of the computer mouse into a pointer or cursor movement on a display medium, for example a computer display screen. The two-dimensional movement of the computer mouse is typically effected by a user's hand. The two-dimensional movement of the computer mouse is converted by the computer mouse, more specifically by a controller of the computer mouse, into electrical signals. The electrical signals are transmitted via a computer mouse cord or a computer mouse cable to a computer, where the electrical signals are then processed and utilized for effecting the pointer movement on the display medium.

The computer mouse cord or computer mouse cable typically includes a number of wires or optical fibers that are bound together and collectively insulated in a common protective sheath or jacket (also known as a cable insulator). Individual wires within the common protective sheath of the computer mouse cable may also be individually insulated. Wires are typically elongated strings of drawn metal or metal alloy, which are typically used for transmission of electricity as well as telecommunication and electrical signals.

Wires can be manufactured or constructed from a wide variety of different metals and metal alloys. Generally, such metals and metal alloys used to manufacture wires must be ductile and of sufficient tensile strength. Some metals conventionally used for the manufacture of wires include copper, aluminum, silver and platinum. In addition, metal alloys such as brass and bronze have been used for the manufacture of wires.

Wires may be classified as solid wires, which are also known as solid-core wires, or stranded wires. Likewise, cables may be classified as solid cables, which are also known as solid-core cables, or stranded cables. Solid wires and solid cables are typically cheaper to manufacture. However, solid wires and solid cables generally lack adequate flexibility. Electrical wires and cables (e.g., computer mouse cables) are typically stranded. Stranded cables include multiple individual wires. Stranded wires include multiple smaller wires that are bundled together. Stranded cables and stranded wires are typically more flexible than solid cables and solid wires of similar sizes. However, increased ‘skin effect’ (a phenomenon whereby current travels near the surface of wires thereby resulting in power loss in wires) may be observed with such stranded cables and stranded wires due to an increased average resistivity that results from inclusion of air gaps between their multiple individual components.

Stranded cables and stranded wires are commonly used with electrical applications that carry small signals, for example with computer mouse cables and with power cables that interconnect moveable devices and their power source.

Computer mouse cables typically need to be significantly flexible to accommodate movement made to the computer mice attached thereto. Increased flexibility of computer mouse cables is increasingly important, and of concern, to garners needing to make quick and precise computer mouse movements so as to effect quick and precise pointer movements on the display screen.

It is a challenge to continually increase the flexibility of computer mouse cables. In addition, kink formation is common in existing computer mouse cables. This is due to inherent cable memories, or wire memories, of the existing computer mouse cables and the wires thereof. Computer mouse cables with kinks formed therein are generally not aesthetically pleasing. In addition, kinked computer mouse cables may not function optimally.

### SUMMARY

The present disclosure describes cables, as well as methods, processes, and techniques for manufacture of the cables. Cables provided by the present disclosure are designed for at least one of enhanced flexibility and reduced propensity for kink formation.

In accordance with a first aspect of the present disclosure, there is provided a cable including a braided cable insulator and a plurality of wires carried by the braided cable insulator. The plurality of wires is spatially organized relative to each other in a predetermined braiding pattern. At least one of the plurality of wires includes a braided wire insulator. The spatial organization of the plurality of wires, the braided wire insulator, and the braided cable insulator at least one of enhances flexibility, increases tensile strength, and reduces a propensity of kink formation of the cable.

In accordance with a second aspect of the present disclosure, there is disclosed a cable including a plurality of cords of wires braided together in a first braiding pattern. Each cord of wires within the plurality of cords of wires includes a plurality of wires braided together in a second braiding pattern. The first braiding pattern and the second braiding pattern facilitate at least one of enhanced flexibility, increased tensile strength, and a reduced propensity of kink formation of the cable

In accordance with a third aspect of the present disclosure, there is disclosed a method for manufacturing a cable, the method including braiding a plurality of wires in a predetermined pattern, and providing a plurality of braided wire insulators, each braided wire insulator within the plurality of wire insulators at least partially surrounding one of the plurality of wires. The method further includes providing a braided cable insulator for circumferentially receiving the plurality of wires therewithin. The braiding of the plurality of wires, the plurality of braided wire insulators, and the braided cable insulator facilitates at least one of enhancing flexibility, increasing tensile strength, and reducing a propensity of kink formation of the cable.

In accordance with a fourth aspect of the present disclosure, there is disclosed a method for manufacturing a cable, the method including braiding a plurality of wires for forming a plurality of cords of wires, each cord of wires within the plurality of cords of wires comprising a subset of the plurality of wires, and braiding the plurality of cords of wires in a predetermined braiding pattern. The braiding of the plurality of wires and the braiding of the plurality of cords of wires facilitates at least one of enhancing flexibility, increasing tensile strength, and reducing a propensity of kink formation, of the cable.

In accordance with a fifth aspect of the present disclosure, there is disclosed a computer peripheral device that includes a housing, a set of transducers carried by the housing, and a set of electrical interface coupled to the set of transducers and carried by the housing. The computer peripheral device further includes a cable coupled to the electrical interface. The cable includes a braided cable insulator and a plurality of wires disposed within the braided cable insulator and spatially organized relative to each other in a predetermined braiding pattern. At least one of the plurality of wires includes a braided wire insulator. The braiding pattern of the plurality of wires, the braided cable insulator, and the braided wire insulator at least one of enhances flexibility, increases tensile strength, and reduces a propensity of kink formation of the cable.

In accordance with a sixth aspect of the present disclosure, there is disclosed a computer peripheral device that includes a housing, a set of transducers carried by the housing, and a set of electrical interface coupled to the set of transducers and carried by the housing. The computer peripheral device further includes a cable coupled to the electrical interface. The cables includes a plurality of cords of wires braided together in a first braiding pattern, each cord of wires within the plurality of cords of wires including a plurality of wires that are braided together in a second braiding pattern. The first braiding pattern and the second braiding pattern facilitate at least one of enhanced flexibility, increased tensile strength, and a reduced propensity of kink formation of the cable.

### BRIEF DESCRIPTION OF THE DRAWINGS

Embodiments of the disclosure are described herein with reference to the drawings, in which:

FIG. 1a shows a computer mouse cable attached to a computer mouse according to an embodiment of the present disclosure;

FIG. 1b shows a cable attached to a headset according to an embodiment of the present disclosure;

FIG. 2 shows a computer mouse cable according to an embodiment of the present disclosure;

FIG. 3 shows another computer mouse cable according to a different embodiment of the present disclosure;

FIG. 4 shows another computer mouse cable according to a different embodiment of the present disclosure; and

FIG. 5 is a flowchart illustrating a method for manufacturing the computer mouse cable according to an embodiment of the present disclosure as shown in FIG. 2.

### DETAILED DESCRIPTION

A computer mouse cable is typically a stranded cable (i.e., includes multiple wires). The computer mouse cable generally needs to be flexible and of adequate tensile strength.

Enhancing the flexibility of computer mouse cables is increasingly important, especially for garners wanting to make quick and precise movements to the computer mouse for effecting quick and precise pointer movements on a display screen. Embodiments of the present disclosure provide cables (e.g., cables attaches to computer peripheral devices such as computer mice and headsets) of enhanced design and construction for enabling at least one of enhanced flexibility and tensile strength.

For purposes of brevity and clarity, embodiments of the present disclosure are described herein as cables of computer peripheral devices (e.g., computer mice and headsets) as well as methods, processes, and techniques for manufacturing said cables. This however does not preclude the present disclosure from other applications where fundamental principles prevalent among the described embodiments of the present disclosure, such as operational, functional or performance characteristics, are required. For example, the present disclosure includes alternative types or models of cables and cords, which can be used with other types of electrical appliances or devices. The present disclosure also includes methods, processes, and techniques for the manufacture of such alternative types or models of cables and cords.

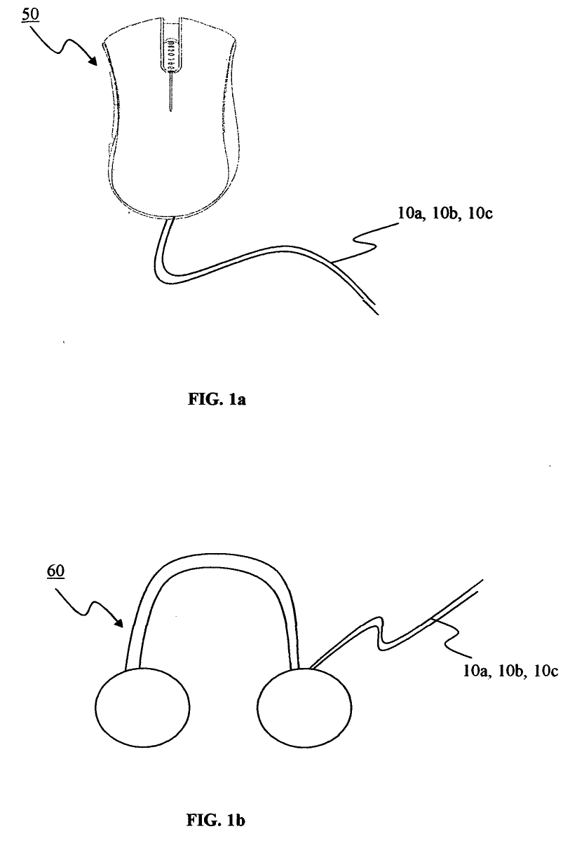

For simplicity and clarity of illustration, various embodiments of the present disclosure are described hereinafter with reference to FIG. 1 to FIG. 5, in which like elements are numbered with like reference numerals.

Each of FIG. 1a and FIG. 1b shows a cable 10a, 10b, 10c according to the present disclosure that is attached to a computer peripheral device, for example a computer mouse 50 and a headset 60. It will be understood by a person of ordinary skill in the art that the cable 10a, 10b, 10c can be attached to an alternative electrical appliance (e.g., a microphone).

In most embodiments, the computer peripheral device (e.g., the computer mouse 50 or the headset 60) includes a housing, a set of transducers carried by the housing, and a set of electrical interfaces (e.g., coupling structures that facilitate electrical path conductivity) coupled to the set of transducers and carried by the housing. The cable 10a, 10b, 10c is attached or coupled to the set of electrical interfaces of the computer peripheral device by techniques known in the art.

In some embodiments, input (e.g., movement) received by the computer peripheral device (e.g., the computer mouse 50) is translated by the set of transducers into signals, which are subsequently transmitted to the cable 10a, 10b, 10c via the electrical interface.

In several embodiments, the signals are transmitted by the cable 10a, 10b, 10c to a controller or computer, which the cable is in signal communication with, for effecting a number of outputs. Such outputs include, but are not limited to, movement of a cursor, or other pointing tool, displayed on a display screen, volume adjustments, and display screen brightness adjustments.

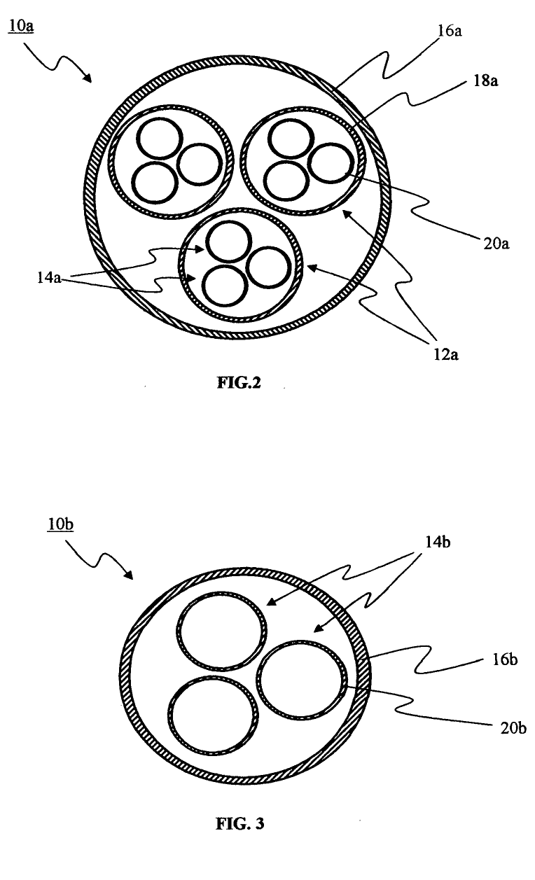

FIG. 2 shows the cable 10a according to an embodiment of the present disclosure. In most embodiments of the present disclosure, the cable 10a is coupled or attached or coupled to a computer peripheral device, for example the computer mouse 50 or the headset 60 (alternatively referred to as a set of headphones).

In most embodiments of the present disclosure, the cable 10a is a computer mouse cable or a computer mouse cord. As shown in FIG. 2, the cable 10a includes a number of bundles of wires. Each of the number of bundles of wires is hereinafter referred to as a cord of wires 12a. In many embodiments, the cable 10a includes two, three, four or five cords of wires 12a. In other embodiments, the cable 10a includes more than five cords of wires 12a. Each cord of wires 12a includes a number of individual wires 14a.

The cable 10a further includes an insulating layer or an insulating sheath, which is hereinafter referred to as a cable insulator 16a. In most embodiments of the present disclosure, the cable insulator 16a is shaped and dimensioned for receiving the cords of wires 12a. In most embodiments of the present disclosure, the cable insulator 16a circumferentially surrounds at least part of the cords of wires 12a. In several embodiments of the present disclosure, the cable insulator 16a wraps around, encapsulates, encloses, or carries the cords of wires 12a therewithin.

The cable insulator 16a of the cable 10a shown in FIG. 2 is made of a material that is braided or woven in a predetermined pattern (i.e., the cable insulator 16a is a braided cable insulator 16a). In most embodiments, the material of the cable insulator 16a is electrically non-conductive. In most embodiments of the present disclosure, the material of the cable insulator 16a is selected based on at least one of cost, aesthetic properties, and resistance to at least one of water, oil, impact, high temperatures, and chemical vapors. In some embodiments of the present disclosure, the cable insulator 16a is manufactured or constructed from flexible composite polymer materials. In other embodiments of the present disclosure, the cable insulator 16a is manufactured from other materials known in the relevant art, for example polyvinyl chloride (PVC), magnesium oxide, and rubber.

In most embodiments of the present disclosure, the cable insulator 16a (i.e., the material of the cable insulator 16a) can have different braiding patterns or styles (also known as weaving patterns or styles). In most embodiments of the present disclosure, the braiding pattern or style of the cable insulator 16a is selected with reference to physical or electrical properties that are associated with the different braiding patterns. For example, a particular braiding pattern may be associated with, or may provide or confer upon the cable insulator 16a, and correspondingly the cable 10a, a different tensile strength or flexibility. In addition, a particular braiding pattern may be associated with, or may provide or confer upon the cable insulator 16a, and correspondingly the cable 10a, a different propensity for kink formation (e.g., a different capacity or level of cable memory).

In most embodiments of the present disclosure, the braiding pattern of the cable insulator 16a is selected for enhancing at least one of flexibility and tensile strength of the cable 10a. In several embodiments of the present disclosure, the braiding pattern of the cable insulator 16a is further selected for enhancing aesthetic properties of the cable insulator 16a. In various embodiments of the present disclosure, the braiding pattern of the cable insulator 16a is selected for reducing a propensity of kink formation of the cable 10a (e.g., by reducing the capacity or level of cable memory).

Braiding, which is also known as a braiding process, a braiding method, or a braiding technique, involves intertwining elongate material such that the elongate material takes on a structured pattern, which is typically referred to as a braiding pattern. Some common braiding patterns include, but are not limited to, French braids, Kumihimo braids and Fingerloop braids. There are other braiding patterns that are known in different technical fields.

The embodiment of the cable 10a as shown in FIG. 2 includes multiple cords of wires 12a that are braided or woven together. The braiding pattern or braiding style of the braided multiple cords of wires 12a can be varied as required. In most embodiments of the present disclosure, the braiding pattern of the multiple cords of wires 12a is selected for enhancing at least one of flexibility and tensile strength of the cable 10a. In various embodiments of the present disclosure, the braiding pattern of the cords of wires 12a is selected for further reducing a propensity of kink formation of the cable 10a (e.g., by reducing the capacity or level of cord or cable memory).

As shown in FIG. 2, each cord of wires 12a includes multiple wires 14a. In most embodiments of the present disclosure, each cord of wires 12a includes three wires 14a. In other embodiments of the present disclosure, each cord of wires 12a includes four, five, six, or more wires 14a.

In most embodiments of the present disclosure, the wires 14a of each cord of wires 12a are braided or woven together in a predetermined braiding pattern. The braiding pattern of the wires 14a of each cord of wires 12a can be selected, and varied, as required. In some embodiments of the present disclosure, the braiding pattern of the wires 14a of each cord of wires 12a is selected for enhancing at least one of flexibility and tensile strength of the cable 10a. In various embodiments of the present disclosure, the braiding pattern of the wires of each cord of wires 12a is selected for further reducing a propensity of kink formation of the cable 10a (e.g., by reducing the capacity or level of cord or cable memory).

In the embodiment of the present disclosure as shown in FIG. 2, each cord of wires 12a has an insulation layer or an insulation sheath, which is hereinafter referred to as a cord insulator 18a. In most embodiments of the present disclosure, the cord insulator 18a is shaped and dimensioned for receiving the cord of wires 12a therewithin. In many embodiments of the present disclosure, the cord insulator 18a circumferentially receives at least part of the cord of wires 12a therewithin. In some embodiments of the present disclosure, the cord insulator 18a wraps around or encapsulates the wires 14a of each cord of wires 12a. In several embodiments of the present disclosure, the cord insulator 18a insulates the wires 14a encapsulated therewithin (e.g., the cord insulator 18a is made of electrically non-conductive material to thereby electrically insulate the wires 14a that are encapsulated therewithin).

In most embodiments of the present disclosure, the cord insulator 18a is manufactured or constructed from a material that is braided or woven in a predetermined pattern (i.e., the cord insulator 18a is a braided cord insulator 18a). The braiding pattern or style of the cord insulators 18a can be selected and varied as required. In most embodiments of the present disclosure, the braiding pattern of cord insulator 18a is selected for enhancing at least one of flexibility and tensile strength of the cable 10a. In various embodiments of the present disclosure, the braiding pattern of the cord insulator 18a is selected for further reducing propensity of kink formation to the cable 10a (e.g., by reducing the capacity or level of cord or cable memory).

In the embodiment of the present disclosure as shown in FIG. 2, each wire 14a includes an insulation layer or an insulation sheath, which is hereinafter referred to as a wire insulator 20a. In most embodiments of the present disclosure, the wire insulator 20a is shaped and dimensioned for receiving one wire 14a therewithin. In many embodiments of the present disclosure, the wire insulator 20a circumferentially receives at least part of the one wire 14a therewithin. In several embodiments of the present disclosure, the wire insulator 20a wraps around or encapsulates at least part of the one wire 14a.

In most embodiments of the present disclosure, the wire insulator 20a is manufactured or constructed from a material that is braided or woven in a predetermined pattern (i.e., the wire insulator 20a is a braided wire insulator 20a). The braiding pattern or style of the wire insulator 20a can be selected and varied as required. In some embodiments of the present disclosure, the braiding pattern of wire insulator 20a is selected for enhancing at least one of flexibility and tensile strength of the cable 10a. In various embodiments of the present disclosure, the braiding pattern of the wire insulator 20a is selected for further reducing propensity of kink formation to the cable 10a.

In some embodiments of the present disclosure, the braiding pattern of each of the cable insulator 16a, the cord insulator 18a, and the wire insulator 20a is identical or similar. In other embodiments of the present disclosure, the braiding pattern of each of the cable insulator 16a, the cord insulator 18a, and the wire insulator 20a is different from at least one of the others. As described above, the braiding pattern of the each of the cable insulator 16a, the cord insulator 18a, and the wire insulator 20a can be selected and varied as required.

In some embodiments of the present disclosure, the cable insulator 16a, the cord insulator 18a, and the wire insulator 20a are manufactured from an identical or similar material. In other embodiments of the present disclosure, the cable insulator 16a, the cord insulator 18a, and the wire insulator 20a are manufactured from different materials. In some embodiments, the material of each of the cable insulator 16a, the cord insulator 18a, and the wire insulator 20a is selected to at least one of enhance flexibility, enhance tensile strength, and reduce propensity to kink formation of the cable 10a.

As described above, the embodiment of the cable 10a as shown in FIG. 2 has multiple braiding layers. The cable 10a includes multiple cords of wires 12a that are braided together. Each cord of wires 12a further includes multiple wires 14a that are braided together. In addition the cable 10a includes the cable insulator 16a, the cord insulator 18a, and the wire insulator 20a. In most embodiments of the present disclosure, each of the cable insulator 16a, the cord insulator 18a, and the wire insulator 20a is manufactured from a braided material (i.e., each of the cable insulator 16a, the cord insulator 18a, and the wire insulator 20a are braided insulators). In most embodiments of the present disclosure, the cable insulator 16a, the cord insulator 18a, and the wire insulator 20a are each braided in a predetermined braiding pattern. In most embodiments of the present disclosure, the multiple braiding layers of the cable 10a increase the overall flexibility of the cable 10a. In some embodiments of the present disclosure, the multiple braiding layers increases tensile strength of the cable 10a. In several embodiments of the present disclosure, the multiple braiding layers of the cable 10a decreases propensity of kink formation in the cable memory, or reduces cable memory of the cable 10a.

Tensile strength, which is generally measured in N/cm², can be defined according to one of yield strength, ultimate strength, and breaking strength. The yield strength typically refers to a value of stress at which the stress applied to a material results in a change from elastic deformation to plastic deformation of the material (i.e., causes the material to deform permanently). The ultimate strength of a material is typically a maximum stress that the material can withstand when subjected to tension, compression, or shearing forces. The breaking strength typically refers to the stress coordinate on a stress-strain curve at the point of breakage or rapture of the material.

In some embodiments of the present disclosure, increase in tensile strength of the cable 10a due to the presence of multiple braiding layers is between approximately 10% and 200% as compared with cables to which no braiding processes or techniques have been applied (e.g., to cables without braiding layers). In other embodiments of the present disclosure, the increase in tensile strength of the cable 10a is of a different amount (e.g., a different percentage increase). In most embodiments, at least one of braiding pattern and material of at least one of the cable insulator 16a, the cord insulator 18a, and the wire insulator 20a, correlates to the amount of increase in tensile strength of the cable 10a.

It is understood by a person skilled in the art that variations to the cable 10a as shown in FIG. 2 are provided by other embodiments of the present disclosure.

FIG. 3 shows another cable 10b provided by an embodiment of the present disclosure. The cable 10b shown in FIG. 3 includes a cable insulator 16b. The cable 10b further includes multiple wires 14b that are at least partly received or encapsulated within the cable insulator 16b. In some embodiments of the present disclosure, the cable 10b includes three wires 14b. In other embodiments of the present disclosure, the cable 10b includes four, five, six, or more wires 14b.

The cable 10b also includes wire insulators 20b that are shaped and dimensioned for at receiving or encapsulating at least a part of the wires 14b. The wires 14b of the cable 10b are braided or woven together in a predetermined braiding pattern, which can be varied as required. Each of the cable insulator 16b and the wire insulator 20b of the cable 10b shown in FIG. 3 is braided (i.e., each of the cable insulator 16b and the wire insulator 20b is manufactured from a braided material, or is considered a braided insulator). In most embodiments of the present disclosure, the material of each of the cable insulator 16b and the wire insulator 20b is selected as required, for example, based upon physical or chemical properties associated with that particular material. The braiding pattern of each of the cable insulator 16b and the wire insulator 20b can also be selected and varied as required. In most embodiments of the present disclosure, the braiding pattern of each of the cable insulator 16b and the wire insulator 20b is selected for enhancing at least one of flexibility and tensile strength of the cable 10b. In some embodiments of the present disclosure, the braiding pattern of each of the cable insulator 16b and the wire insulator 20b is selected for reducing propensity of kink formation to the cable 10b.

In most embodiments of the present disclosure, the braiding of the multiple wires 14b of the cable 10b, the cable insulator 16b, and the wire insulator 20b enhances the overall flexibility of the cable 10b. In some embodiments of the present disclosure, the braiding of the multiple wires 14b of the cable 10b, the cable insulator 16b, and the wire insulator 20b increases tensile strength of the cable 10b. In several embodiments of the present disclosure, the braiding of the wires 14b of the cable 10b, the cable insulator 16b, and the wire insulator 20b decreases propensity of kink formation in the cable memory, or reduces cable memory of the cable 10b.

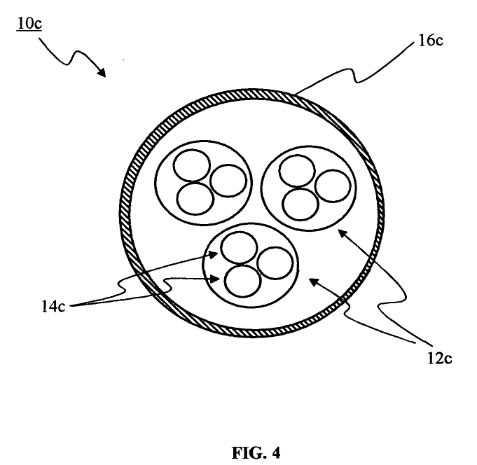

FIG. 4 shows another cable 10c provided by an embodiment of the present disclosure. As shown in FIG. 4, the cable 10c includes a cable insulator 16c and a number of cords of wires 12c that are encapsulated within the cable insulator 16c. Each cord of wires 12c includes multiple wires 14c. In some embodiments of the present disclosure, the cable 10c includes three cords of wires 12c. In other embodiments of the present disclosure, the cable 10c includes four, five, six, or more cords of wires 12c. In some embodiments of the present disclosure, each cord of wires 12c includes three wires 14c. In other embodiments of the present disclosure, each cord of wires 12c includes four, five, six, or more wires 14c.

The cable insulator 16c is braided (i.e., the cable insulator 16c is manufactured from a braided material, and is considered to be a braided insulator). The braiding pattern of the cable insulator 16c can be selected and varied as required. The multiple cords of wires 12c of the cable 10c shown in FIG. 4 are braided together in a predetermined braiding pattern. In addition, the multiple wires 14c of each cord of wires 12c are also braided together in a predetermined braiding pattern. The braiding patterns of the cords of wires 12c, and the wires 14c of each cord of wires 12c, can be selected and varied as required.

In most embodiments of the present disclosure, the braiding patterns of the cable insulator 16c, the cords of wires 12c, and the wires 14c of each cord of wires 12c are selected for enhancing at least one of flexibility and tensile strength of the cable 10c. In some embodiments of the present disclosure, the braiding patterns of the cable insulator 16c, the cords of wires 12c, and the wires 14c of each cord of wires 12c are selected for reducing propensity of kink formation to the cable 10c.

As with the embodiments shown in FIG. 2 and FIG. 3, the braiding of cable insulator 16c, the cords of wires 12c, and the wires 14c of each cord of wires 12c enhances the overall flexibility of the cable 10c. In some embodiments of the present disclosure, the braiding of cable insulator 16c, the cords of wires 12c, and the wires 14c of each cord of wires 12c increases tensile strength of the cable 10c. In several embodiments of the present disclosure, the braiding of cable insulator 16c, the cords of wires 12c, and the wires 14c of each cord of wires 12c decreases propensity of kink formation to the cable memory, or reduces cable memory of the cable 10c.

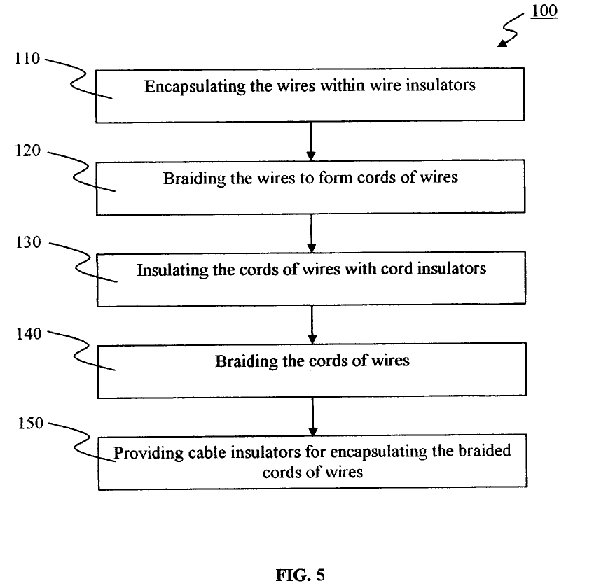

FIG. 5 is a flowchart of a process 100 for manufacturing the cable 10a of FIG. 2 according to an embodiment of the present disclosure.

In a first process portion 110 of the process 100, each wire 14a of the cable 10a is at least partially surrounded by an individual wire insulator 20a. In many embodiments of the present disclosure, each wire 14a of the cable 10a is carried by or received within one wire insulator 20a. In some embodiments of the present disclosure, each wire 14a of the cable 10a is encapsulated within one wire insulator 20a. The wire insulators 20a help to insulate (e.g., electrically insulate) the wires 14a.

In most embodiments of the present disclosure, the wire insulator 20a is manufactured by a braiding or a weaving process (i.e., the wire insulator 20a is a braided wire insulator 20a). The braiding pattern of the wire insulator 20a can be selected and can be varied as required. In addition, the material of the wire insulator 20a can be selected as required, for example based on at least one physical or chemical property of the material.

In a second process portion 120, the wires 14a are braided or woven together in a predetermined pattern to form multiple cords of wires 12a. Each cord of wires 12a includes a subset of the wires 14 braided together in a predetermined braiding pattern. In some embodiments of the present disclosure, each cord of wires 12a includes three wires 14a. In other embodiments of the present disclosure, each cord of wires 12a includes four, five, six, or more wires 14a. It is understood by a person skilled in the art provided with the disclosure of the present description that different braiding processes or techniques can be employed for braiding the wires 14a. In most embodiments of the present disclosure, the braiding of the wires 14a enhances stability of the spatial arrangement or organization of the wires 14a. In most embodiments of the present disclosure, the braiding pattern of the subset of wires 14a of each cord of wires 12a is selected for enhancing at least one of flexibility and tensile strength of the cable 10a. In several embodiments of the present disclosure, the braiding pattern of the subset of wires 14a of each cord of wires 12a is selected for reducing propensity of kink formation to the cable 10a.

In a third process portion 130, each cord of wires 12a is at least partially surrounded or encapsulated by one cord insulator 18a. In most embodiments of the present disclosure, each cord of wires 12a is circumferentially received by one cord insulator 18a. In many embodiments of the present disclosure, each cord of wires 12a is encapsulated and insulated (e.g., electrically insulated) by one cord insulator 18a. As described above, the cord insulator 18a is braided (i.e., manufactured from a material that is braided) in a predetermined braiding pattern. The braiding pattern of the cord insulator 18a is selected, and can be varied, as required using techniques known in the art. In addition, the material of the cord insulator 18a can be selected as required, for example based on at least one physical or chemical property of the material.

In a fourth process portion 140, the multiple cords of wires 12a are braided together in a predetermined braiding pattern. As previously described, the braiding pattern of the multiple cords of wires 12a is selected, and can be varied, as required. Braiding of the multiple cords of wires 12a can be performed by braiding processes or techniques that are known in the art. In most embodiments of the present disclosure, the braiding of the multiple cords of wires 12a enhances stability of the spatial arrangement of the multiple cords of wires 12a. In most embodiments of the present disclosure, the braiding pattern of the cords of wires 12a is selected for enhancing at least one of flexibility and tensile strength of the cable 10a. In several embodiments of the present disclosure, the braiding pattern of the cords of wires 12a is selected for reducing a propensity of kink formation of the cable 10a.

In a fifth process portion 150, the cable insulator 16a is provided and the cords of wires 12a are collectively carried by the cable insulator 16a. In most embodiments of the present disclosure, the cable insulator 16a circumferentially carries the cord of wires 12a. In many embodiments of the present disclosure, the cable insulator 16a surrounds or encapsulates the cords of wires 12a. The cable insulator 16a is made of material that is braided or woven together in a predetermined braiding pattern (i.e., the cable insulator 16a is braided). The braiding pattern of the cable insulator 16a is selected, and can be varied, as required. In addition, the material of the cable insulator 16a can be selected as required, for example based on at least one physical or chemical property of the material.

In most embodiments of the present disclosure, the braiding pattern of at least one of the cable insulator 16a, the cord insulator 18a, and the wire insulator 20a is selected for enhancing at least one of flexibility and tensile strength of the cable 10a. In some embodiments of the present disclosure, the braiding pattern of at least one of the cable insulator 16a, the cord insulator 18a, and the wire insulator 20a is selected for reducing a propensity of kink formation of the cable 10a.

In most embodiments of the present disclosure, the method 100 enables the manufacture of cables 10a of an enhanced flexibility compared to existing cables 10a. The braided structure of the cords of wires 12a, and the individual wires 14a of each cord of wires 12a, enable the cords of wires 12a, and the individual wires 14a of each cord of wires 12a, to move slightly relative each other to thereby enhance the overall flexibility of the cables 10a.

Cables (such as the cables 10a, 10b, 10c provided by the present disclosure) with enhanced flexibility are increasingly desired, especially for computer garners wanting to make a quick and precise computer mouse movement for effecting a corresponding quick and precise movement to a pointer on the display screen. In some embodiments of the present disclosure, the method 100 enables manufacture of cables (such as cables 10a, 10b, 10c provided by the present disclosure) of significantly reduced propensity for kink formation (e.g., cables having a reduced cable memory). Reduced occurrence of kink formation in cables is increasingly desired for aesthetical reasons and typically increases the retail value of cables.

It will be understood by a person skilled in the art that the sequence of the process portions 110 to 150 can be altered as required. In addition, the process 100 according to an embodiment of the present disclosure can be modified for the manufacture of the cables according to other embodiments of the present disclosure, such as the cables 10b and 10c as shown FIG. 3 and FIG. 4. The process 100 can also be applied for manufacturing cables coupled or attached to other types of computer peripheral devices, and to other electrical appliances or devices.

In the foregoing disclosure, cables, for example cables attached to computer peripheral devices such as computer mice and headsets, and processes for the manufacture thereof, have been described. It will be appreciated by a person skilled in the art that the described process according to an embodiment of the present disclosure can be applied to other cables or cords, which can be attached to alternative electrical, mechanical, or electromechanical devices. In addition, although only exemplary cables and processes are described in this disclosure, it will be appreciated by a person skilled in the art in view of this disclosure that numerous changes and/or modifications, both structurally and functionally, can be made to the exemplary cables and process without departing from the scope, intention or spirit of the present invention.

1. A cable comprising:
a braided cable insulator; and
a plurality of wires carried by the braided cable insulator and spatially organized relative to each other in a predetermined braiding pattern, at least one of the plurality of wires comprising a braided wire insulator,
wherein the spatial organization of the plurality of wires, the braided wire insulator, and the braided cable insulator at least one of enhances flexibility, increases tensile strength, and reduces a propensity of kink formation of the cable.

2. The cable as in claim 1, further comprising a plurality of braided cord insulators, each braided cord insulator within the plurality of braided cord insulators carrying a subset of wires within the plurality of wires, wherein each braided cord insulator within the plurality of braided cord insulators and the subset of wires carried thereby form a cord of wires.

3. The cable as in claim 2, wherein the subset of the plurality of wires carried by each braided cord insulator within the plurality of braided cord insulators is braided together in a predetermined braiding pattern.

4. The cable as in claim 2, wherein a plurality of cords of wires are braided together in a predetermined braiding pattern.

5. The cable as in claim 4, wherein a braiding pattern of each of the braided cable insulator, the braided wire insulator, the braided cord insulator, the subset of the plurality of wires carried by each braided cord insulator within the plurality of braided cord insulators, and the plurality of cords of wires, at least one of enhances flexibility, increases tensile strength, and reduces a propensity of kink formation of the cable.

6. The cable as in claim 1, wherein the cable comprises one of a mouse cable, a USB cable, and a computer cable.

7. A cable comprising:
a plurality of cords of wires braided together in a first braiding pattern, each cord of wires within the plurality of cords of wires comprising a plurality of wires braided together in a second braiding pattern,
wherein the first braiding pattern and the second braiding pattern facilitate at least one of enhanced flexibility, increased tensile strength, and a reduced propensity of kink formation of the cable

8. The cable as in claim 7, wherein the first and second braiding patterns are identical.

9. The cable as in claim 7, further comprising a braided cable insulator circumferentially receiving the plurality of cords of wires.

10. The cable as in claim 9, further comprising a plurality of cord insulators, each cord insulator within the plurality of cord insulators circumferentially receiving a cord of wires within the plurality of cords of wires.

11. The cable as in claim 10, further comprising a plurality of wire insulators, each wire insulator within the plurality of wire insulators at least partially surrounding a cord of wires within the plurality of cords of wires.

12. The cable as in claim 11, wherein the braided cable insulator, the plurality of cord insulators, and the plurality of wire insulators has a braiding pattern that at least one of enhances flexibility, increases tensile strength, and reduces a propensity of kink formation of the cable.

13. The cable of claim 12, wherein the braiding pattern of the braided cable insulator, the plurality of cord insulators, and the plurality of wire insulators are identical.

14. The cable as in claim 13, wherein the cable is one of a mouse cable, a USB cable, and a computer cable.

15. A method for manufacturing a cable, the method comprising:
braiding a plurality of wires in a predetermined pattern,
providing a plurality of braided wire insulators, each braided wire insulator within the plurality of wire insulators at least partially surrounding one of the plurality of wires,
providing a braided cable insulator for circumferentially receiving the plurality of wires therewithin,
wherein the braiding of the plurality of wires, the plurality of braided wire insulators, and the braided cable insulator facilitates at least one of enhancing flexibility, increasing tensile strength, and reducing a propensity of kink formation of the cable.

16. The method as in claim 15, further comprising forming a plurality of cords of wires, wherein each cord of wires within the plurality of cords of wires comprises a subset of the plurality of wires.

17. The method as in claim 16, wherein the subset of the plurality of wires of each cord of wires within the plurality of cords of wires are braided together in a predetermined pattern.

18. The method as in claim 17, further comprising:
providing a plurality of braided cord insulators, each braided cord insulator within the plurality of braided cord insulators circumferentially surrounds one cord of wires within the plurality of cords of wires.

19. The method as in claim 18, wherein the braided cable insulator, the plurality of braided cord insulators, and the plurality of braided wire insulators have a braiding pattern that at least one of enhances flexibility, increases tensile strength, and reduces a propensity of kink formation of the cable.

20. A method for manufacturing a cable, the method comprising:
braiding a plurality of wires for forming a plurality of cords of wires, each cord of wires within the plurality of cords of wires comprising a subset of the plurality of wires; and
braiding the plurality of cords of wires in a predetermined braiding pattern,
wherein the braiding of the plurality of wires and the braiding of the plurality of cords of wires facilitates at least one of enhancing flexibility, increasing tensile strength, and reducing a propensity of kink formation, of the cable.

21. The method as in claim 20, further comprising:
providing a braided cable insulator that circumferentially receives the plurality of cords of wires.

22. The method as in claim 19, further comprising:
providing a plurality of braided cord insulators, each braided cord insulator within the plurality of braided cord insulators at least partially surrounding one of the plurality of cords of wires.

23. The method as in claim 22, further comprising:
providing a plurality of braided wire insulators, each braided wire insulator within the plurality of braided wire insulators at least partially surrounding one of the plurality of wires.

24. The method as in claim 21, wherein the braided cable insulator, the plurality of cord insulators, and the plurality of wire insulators have a braiding pattern that is selected for facilitating at least one of enhancing flexibility, increasing tensile strength, and reducing a propensity of kink formation, of the cable.

25. A computer peripheral device comprising:
a housing;
a set of transducers carried by the housing;
a set of electrical interfaces coupled to the set of transducers and carried by the housing; and
a cable coupled to the set of electrical interfaces, the cable comprising:
a braided cable insulator; and
a plurality of wires disposed within the braided cable insulator and spatially organized relative to each other in a predetermined braiding pattern, at least one of the plurality of wires comprising a braided wire insulator,
wherein the braiding pattern of the plurality of wires, the braided cable insulator, and the braided wire insulator at least one of enhances flexibility, increases tensile strength, and reduces a propensity of kink formation of the cable.

26. The computer peripheral device as in claim 25, wherein the computer peripheral device comprises at least one of a computer mouse and a set of headphones.

27. A computer peripheral device comprising:
a housing;
a set of transducers carried by the housing;
a set of electrical interfaces coupled to the set of transducers and carried by the housing; and
a cable coupled to the set of electrical interfaces, the cable comprising:
a plurality of cords of wires braided together in a first braiding pattern, each cord of wires within the plurality of cords of wires comprising a plurality of wires that are braided together in a second braiding pattern,
wherein the first braiding pattern and the second braiding pattern facilitate at least one of enhanced flexibility, increased tensile strength, and a reduced propensity of kink formation of the cable.

29. The computer peripheral device as in claim 28, wherein the computer peripheral device comprises at least one of a computer mouse and a set of headphones.
